(19) United States
(12) Patent Application Publication
(10) Pub. No.: US 2019/0174338 A1
(43) Pub. Date: Jun. 6, 2019

(54) Band Monitoring Device for a Radio Communication System

(71) Applicant: Kunbus GmbH, Denkendorf (DE)

(72) Inventors: Gerd SCHOLL, Hamburg (DE); Ralf HEYNICKE, Ratzeburg (DE); Dmytro KRUSH, Hamburg (DE); Rainer HORNUNG, Reutlingen (DE); Thomas SOLZBACHER, Zeven (DE)

(21) Appl. No.: 16/271,249

(22) Filed: Feb. 8, 2019

Related U.S. Application Data
(63) Continuation of application No. PCT/EP2017/068411, filed on Jul. 20, 2017.

(30) Foreign Application Priority Data
Aug. 12, 2016 (EP) 16184067.3

(51) Int. Cl. H04W 24/08

(52) U.S. Cl. CPC H04W 24/08

(57) ABSTRACT

A band monitoring device for a radio communication system in which each of a plurality of subscribers is allocated a fixed sequence of frequencies f to be used comprises: a detector to determine a time-frequency representation of a usage of at least one frequency band of the radio communication system; a memory to store the fixed sequences; and an evaluation unit to divide the time-frequency representation into a first component that is plausible with the fixed sequences and into a second component that is inconsistent with the fixed sequence.

### CROSS REFERENCE TO RELATED APPLICATIONS

This application is a continuation of International Application No. PCT/EP2017/068411, filed on Jul. 20, 2017, which claims priority under 35 U.S.C. § 119 to Application No. EP16184067.3 filed on Aug. 12, 2016, the entire contents of which are hereby incorporated by reference.

### TECHNICAL FIELD

The described system relates to a band monitoring device for detecting jammers in a radio communication system, in particular, in a wireless sensor-actuator network in the industrial environment; a radio communication system; and a control system.

### BACKGROUND

In distributed industrial control systems, radio communication systems are increasingly being used as the physical medium for communication with the sensors and actuators. For example, in manufacturing automation or process automation, one or more central base stations communicate with a large number of other subscribers. Such networks are known, for example, from DE 10 2009 054 527 A1 and from DE 10 2009 046 503 A1.

The control processes are usually time critical, making it absolutely mandatory to adhere to a specified latency time, since, otherwise, there is the immediate risk of production downtimes or even damage to the equipment. In hard-wired networks it is necessary, for example, that cyclic process data be exchanged, according to the IO-Link standard, between a central base station and 100 other subscribers within a guaranteed latency time of 10 ms. The probability of exceeding 10 ms may not exceed 10⁻⁹. The same specification applies to wireless sensor-actuator networks in industrial environments.

Since the radio channel is time variant and frequency selective, it can happen repeatedly that a single frequency is temporarily not usable. Therefore, each subscriber is allocated a hopping algorithm, according to which it changes the frequency used in rapid succession. Then a fault on one frequency only has an effect until the next frequency change. Each subscriber may occupy the spectrum only within the allocated frequencies, times, and transmission powers (coexistence management).

One problem in this context is that radio communication systems for critical applications often have to share the frequency bands that are used with a large number of other radio applications for practical and economic reasons. For example, the particularly preferred 2.4 GHz ISM band is also used for WLAN, Bluetooth and other short range radio applications. At the same time microwave ovens and other systems, which use for the purpose of thermal input powers that are higher by several orders of magnitude than is typical for short range radio applications, also work in this band. Small high frequency leaks in these systems can significantly disrupt the communication.

### SUMMARY

Therefore, an object of the described system is to provide the capability in radio communication systems for critical applications to detect faults at an early stage and to minimize the effects of such faults.

Within the context of the described system, a band monitoring device was developed for a radio communication system, in which each subscriber is allocated a fixed sequence of frequencies to be used. The fixed sequence can be, in particular, cyclic or alternatively can be repeated cyclically. The band monitoring device comprises a detector for determining a time-frequency representation of the usage of at least one frequency band of the radio communication system. In particular, it is possible to record the received signal strength, resolved according to time and frequency. In principle, however, it is sufficient to record in binary form whether one frequency is used at a time (1) or not (0).

According to the described system, the band monitoring device additionally comprises a memory for the fixed sequences and an evaluation unit. This evaluation unit is designed to divide the time-frequency representation into a component that is plausible with the fixed sequences and into a component that is inconsistent with the fixed sequences. Thus, the band monitoring device functions as a MAC profiler (MAC=Media Access Control, access control to the physical medium radio channel).

It has been recognized that the comparison of the actual frequency usage with the fixed sequences, allocated to the individual subscribers, in particular, in a radio communication system with many subscribers, is a reliable and at the same time quickly testable criterion for the detection of faults. The European Telecommunications Standards Institute, ETSI, has prescribed for systems operated in parallel that they may not be actively synchronized on a common time base. Even within a system, the time bases of the subscribers can drift apart. However, the sequence of frequencies used remains distinctive and can be easily recognized again by each subscriber, just as a melody is recognized again within wide limits independently of the speed, at which it is played, and the point in time that it is employed.

According to the prior art to date, the frequency spectrum has been rudimentarily analyzed in any event by the subscribers of the radio communication system in order to be able to determine prior to transmission whether the frequency is free. The band monitoring device typically analyzes the frequency usage on a much faster time scale.

The subscribers are generally incoherent sources in relation to each other. The superposition principle applies, according to which the signals of the subscribers overlap linearly. For example, the component of the time-frequency representation that is plausible with the fixed sequences of the individual subscribers can be modeled as a weighted linear sum of the contributions of the individual subscribers. In this case, for example, the weights and an offset in time between the subscribers due to the drifting apart of the time bases can be optimized for the best possible match as a fit parameter. Then, the difference between the actual time-frequency representation and the plausible component can be rated as the component that is inconsistent with the fixed sequences. Therefore, the fixed sequences, stored in the memory, indicate to the band monitoring device, which frequencies are nominally occupied at which times in the next time (millisecond to second range).

In networks in which there is a fixed synchronization of the subscribers with each other on a common time base, the expected frequency usage can be stored in a simplified fashion as a matrix having columns that denote discrete frequency channels and having rows that denote the various times at which the frequency usage is determined. Then the matrix entries may denote, for example, the expected signal levels. Then one row of the matrix can be analyzed at any time as to whether the expected signal levels correspond to the observed signal levels. If this is the case, then the frequency usage is completely plausible with the fixed sequences that are allocated to the individual subscribers. Otherwise, there is at least one error or, more specifically, source of interference in the system.

The knowledge of the inconsistent component can be used in a variety of ways to control the fault and/or to lessen its impact. If, for example, a specific frequency is affected, then the sequence of frequencies used by one or more subscribers can be adapted such that the perturbed frequency is removed. As an alternative or also in combination therewith, the inconsistent component can be further evaluated in order to find the source of the interference and ultimately to eliminate it. Furthermore, the system can be put into a safety state, in which the impact of non-adherence to the predetermined latency time is minimized.

The band monitoring device comprises advantageously a communication unit, with which the band monitoring device can be integrated in the radio communication system as a subscriber. Then the band monitoring device can be parameterized and configured in the same way as well as can transmit its measurement and evaluation results, like the other sensors in the radio communication system. For example, any engineering tool of standard automation technology can be used for this purpose. For example, in this way the fixed sequences can be loaded into the memory. In this way, the band monitoring device can also obtain, for example, a positive list (white list) of subranges of the frequency band that are actually used by the radio communication system and/or a negative list (black list) of subranges of the frequency band that are not used by the radio communication system. Thus, for example, when a wireless industrial sensor-actuator network is operating in parallel with multiple WLAN networks, the wireless sensor-actuator network may be configured such that it works only in the spaces between the ranges used by the WLAN networks.

In particular, a band monitoring device, which is at least temporarily integrated in the radio communication system as a subscriber, can automatically obtain the fixed sequences of the frequencies, to be used by the individual subscribers, and/or the transmission times. For this purpose, the band monitoring device can also be integrated, in particular, in a plurality of such systems in each case as a subscriber. In this way, the band monitoring device receives all the information about the authorized media access in its environment.

In an additional implementation, the band monitoring device comprises a communication unit that can be connected to a wireless or hard-wired communication network that is different from the radio communication system. In this way, the band monitoring device can still transmit detail information about the fault, even if the fault is already so massive that the band monitoring device can no longer use the actual radio communication system for this transmission.

For example, the band monitoring device may be integrated in a device that is already a subscriber of the radio communication system and fulfills another function. For example, the band monitoring device may be integrated in a base station or in a sensor or actuator module as an additional functionality. Advantageously, however, the band monitoring device is an autonomous device. In particular, it can then be placed in a location, where it proactively warns against faults, before the actual subscribers of the radio communication system suffer noticeable losses as a result of these faults.

The band monitoring device can be produced, for example, by exchanging the firmware consisting of a sensor or actuator module or any other subscriber device that has at least a basic hardware configuration for determining the time-frequency representation of the frequency band. In this way, for example, out-of-date or defective devices that can no longer fulfill their primary function can be reused. Advantageously, however, the band monitoring device is optimized in terms of hardware specifically for this task.

In another implementation of the described system, the detector comprises a plurality of simultaneously operating receivers, which are each sensitive to a fixed frequency and/or to a fixed frequency sub-band at a predetermined time, within the frequency band. In this way the time-frequency representation can be determined with a particularly high time-out. For example, the current use of the frequency range of 2400 MHz to 2480 MHz, which is of interest for wireless industrial sensor-actuator networks, can be detected in less than 45 μs with 80 receivers, which are each sensitive to a frequency sub-band of 1 MHz. Such a detector is fast enough, for example, to detect faults by Bluetooth devices that sporadically distribute short pulses of 64 μs duration over a wide frequency spectrum in the scanning mode. WLAN burst signals are also sporadic faults that can only be detected if the sampling rate of the spectrum analyzer is sufficiently fast.

However, spectrum analyzers, which are based on a sweep method and which only receive on one frequency at a time, need a period of a few milliseconds to scan, for instance, the 2.4 GHz ISM band. Only after this period of time has elapsed can a statement be made about the current occupancy of the frequency range. If the jammer is timed and/or if it is a frequency agile system, then the jammer is only visible, if the spectrum analyzer happens to be measuring at the same frequency, on which the jammer is currently transmitting. Thus, a frequency-agile jammer cannot be adequately explained with a relatively slow sweeping spectrum analyzer or rather can be explained only at the expense of a great deal of time.

With so-called real-time spectrum analyzers, the entire frequency band can be detected or, more specifically, analyzed simultaneously. However, these analyzers are extremely expensive and can only observe the frequency band with considerable time gaps due to the high amount of computational time required for the data analysis. Furthermore, the HF input branch has a bandwidth that is at least as large as the receiving range to be examined. As a result, the transmitter with the strongest reception level determines the dynamic range of the entire analyzer. Therefore, weak signals may not be measured simultaneously with strong signals. In contrast, the detector, which comprises, according to the example implementation described, a plurality of independent receivers, offers the advantage that each of the independent receivers has its independently selectable dynamic range.

In another implementation of the described system, an additional memory is provided for the signal characteristics of the subscribers that are to be expected at the location of the band monitoring device. These signal characteristics may comprise, in particular, the signal strength. The evaluation unit is designed to compare the signal characteristics of a frequency usage, which is plausible with the fixed sequence of a subscriber, with the expected signal characteristics of the signal received from the subscriber.

In this way, for example, it is possible to detect operating errors or alternatively misconfigurations to the effect that a subscriber is duplicated in the system. Such errors may occur, for example, when a device is replaced by a new one at one location, and the old device is reused at another location without first deleting its network configuration.

It is particularly advantageous, if the evaluation unit is designed to detect a deviation of the signal characteristics from the expected signal characteristics as an attempt to break into the radio communication system by simulating the identity of a subscriber. Since the required latency times are very short and at the same time the subscriber devices usually have only a low computing power, it is often impractical to cryptographically secure the communication in the radio communication system in accordance with the same high standard as in a WLAN. With a sufficiently clear view of the location it is conceivable to attempt a break-in at longer ranges by using, for example, directional antennas. Similar attacks with radio range extenders already exist on remote keys of passenger vehicles.

The fixed sequences of the frequency usage that are allocated to the individual subscribers and/or the signal characteristics to be expected can be supplied by the communication unit to the respective memories as a priori knowledge. The fixed sequences are centrally defined and should, therefore, be known. In contrast, the signal characteristics to be expected at any location within the system are difficult to figure out in advance, especially since the radio propagation, for example, in an industrial manufacturing plant is subject to uncertainties due to shadings and reflections. Therefore, in another implementation of the described system, the evaluation unit can be switched into a learning mode, in which it determines the fixed sequences and/or the expected signal characteristics from the time-frequency representation. Therefore, it is possible to automatically detect and store the fault-free normal state in the memories of the band monitoring device without further action by the user, so that later changes can be registered by the band monitoring device.

Such a learning mode can be used, for example, for synchronizing in time with one or more radio communication systems, i.e., for obtaining the information as to when a known fixed sequence of transmissions on different frequencies should begin exactly. Then the band monitoring device knows at any time the authorized transmission frequencies.

In one example implementation, the detector is designed to record a time-frequency representation during at least one send pause assigned to at least one subscriber by the radio network. If, for example, the band monitoring device is arranged very close to a subscriber device, which in turn is relatively far from the base station, then this subscriber device will send a fairly strong signal, in order to reach the base station. At the location of the band monitoring device this signal will be much stronger than the signals from other, more distant subscribers and may partially obscure them. When the strong signal pauses, the weaker signals can be resolved better. In particular, the detector can be designed to record a time-frequency representation during a send pause that is valid throughout the entire radio communication system. A frequency usage during this time is then established directly as inconsistent, i.e., as a fault, with the fixed sequences of all of the subscribers. The earlier the fault is detected, the more time remains for countermeasures to either eliminate the cause of the fault or at least mitigate the consequences of the fault.

In a further implementation of the described system, the evaluation unit is designed to identify a frequency usage as a frequency usage that is in conformity with the IO-Link standard, with a WLAN standard and/or with a Bluetooth standard. These standards are the three main short-range radio applications that coexist in the 2.4 GHz band. If the type of an interfering frequency usage is isolated in this way, it is much easier to remedy the fault in the final end. The 2.4 GHz band is very heavily frequented, but in many cases it is more advantageous than the much emptier 5 GHz band for three reasons:

the range that can be achieved with the same power is greater, especially if there is no line of sight that is totally free between transmitter and receiver;

at the present time 5 GHz radio modules still require about 10 times more power than 2.4 GHz radio modules;

large portions of the 5 GHz band are allocated to radar systems for primary usage.

Other radio systems must periodically monitor their respective frequency for radar signals and, if necessary, immediately stop the operation (DFS technology).

The described system relates to a radio communication system that supplies a spatial region, such as an industrial manufacturing plant. According to the described system, at least one band monitoring device is arranged in an edge region of the region, and/or at an access to the region supplied. An edge region is defined, in particular, as a region, whose distance from the central base station is at least 75% of the distance of the subscriber, furthest away from the base station, from the base station. In particular, an access may be, for example, a door, through which a closed room, such as, for example, a shop, housing the radio communication system, can be entered.

It has been recognized that most faults in radio communication systems of industrial plants are caused by external sources of interference, such as WLAN or Bluetooth-enabled devices that are brought into the systems and that automatically attempt to establish a connection. Due to the proactive placement of the band monitoring device in the edge region or at the entrance, such a source of interference can be detected at an early stage. For example, an alarm may be triggered and the person, who has the source of interference on him, may be denied further access at a time, when none of the subscribers is affected or only a few subscribers are affected by the fault. If, however, the source of interference has already penetrated into the vicinity of the central base station, then in the worst case it can overlap the signal of most of the other subscribers, so that the entire network fails.

As an alternative or in combination therewith, it is thus also advantageous to arrange a band monitoring device near a central base station of the radio communication system, since a fault that can be perceived at this location will soon affect with high probability the entire network. The band monitoring device at this location “hears” in essence the same signals as the base station meaning that the band monitoring device has an accurate image of the frequency usage perceived by the base station. However, it does not interpret the signals logically in the sense of the protocol used in the radio communication system, but rather only analyzes the negative effects, which may or may not result from the signals, on the closed loop control.

The described system also relates to a distributed industrial control system having a radio communication system that comprises at least one band monitoring device. According to the described system, at least one control device of the control system is coupled to the band monitoring device and is designed to put, triggered by the detection by the band monitoring device of a component of the frequency usage that is inconsistent with the planned frequency usage in the radio communication system, the control system into a safety state, in which the effect of a fault in the radio communication system is reduced. The control device may be, for example, a programmable logic controller (PLC).

It has been recognized that a fault in the radio communication system can sometimes have the impact of causing faults in the controlled process and/or causing damage to equipment much faster than the cause of the fault can be remedied. By putting the control system into a safety state, this adverse effect can be minimized; and, in particular, permanent damage can be avoided.

For example, the maximum tolerable latency time during the radio transmission in the radio communication system may be increased in the safety state. For this purpose it is advantageous if, for example, the operating speed of a device, controlled by the control system, can be reduced in comparison with the normal operating mode. If, for example, a bottling plant for beverages operates at a reduced throughput during the fault, then this situation is a lesser evil than having to search the entire plant for the glass splinters after a collision of bottles.

### BRIEF DESCRIPTION OF THE DRAWINGS

The subject matter of the described system will be explained below with reference to figures without limiting the subject matter of the described system thereto.

FIG. 1 shows an example implementation of the band monitoring device 1; and embedding of the same in a radio communication system 100 and a control system 300.

FIG. 2 shows an example implementation of a fast spectrum analyzer 2 comprising a plurality of simultaneously operating receivers 21a-21h.

FIGS. 3a and 3b show an example implementation of an analysis of a time-frequency representation 20.

FIG. 4 shows an arrangement of band monitoring devices 1a-1d for the earliest possible detection of jammers 9a, 9b.

FIG. 5 shows joint band monitoring device 1 for two radio communication systems 100, 120.

### DETAILED DESCRIPTION

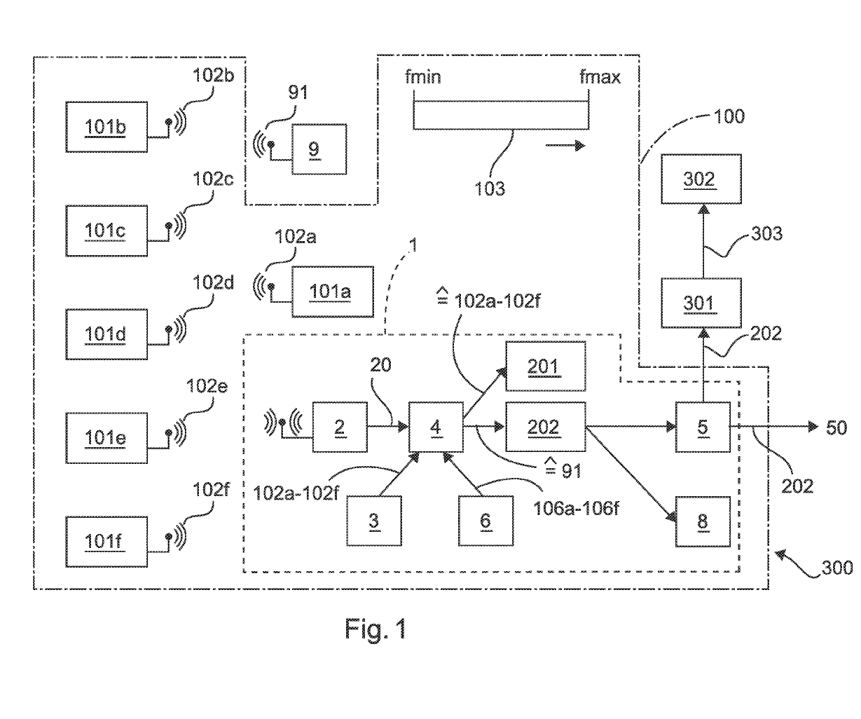

FIG. 1 shows an example implementation of a band monitoring device 1. The band monitoring device 1 comprises a detector 2, which produces a time-frequency representation 20 of the usage of the frequency band 103, used by the radio communication system 100, between the frequencies fₘᵢₙ and fₘₐₓ. This time-frequency representation 20 is supplied to the evaluation unit 4, which at the same time retrieves the fixed sequences 102a-102f of the frequencies f, which are to be used by the subscribers 101a-101f, from a memory 3 and the signal strengths 106a-106f of the subscribers 101a-101f, which are to be expected at the location of the band monitoring device 1, from a memory 6. The a priori information 102a-102f, 106a-106f from the memories 3 and 6 is used by the evaluation unit 4 to divide the time-frequency representation 20 of the frequency usage into a component 201, which comes from the subscribers 101a-101f and which is plausible with their fixed sequences 102a-102f, and a fault component 202 that is inconsistent with these fixed sequences 102a-102f In particular, when a comparison is made as to whether the signal characteristics of the frequency usage are plausible with the fixed sequences 102a-102f of the subscribers 101a-101f, the signal strength is used as the signal characteristic.

In the example implementation shown in FIG. 1, the first subscriber 101a is the central base station of the radio communication system 100. The subscribers 101b-101f are sensor/actuator modules. In addition, there is also a jammer 9, whose frequency usage, which does not conform with the radio communication system 100, follows the pattern 91. As a result of the comparison with the fixed sequences 102a-102f, the evaluation unit 4 detects exactly this frequency usage 91 as a fault and assigns it to the fault component 202.

The fault component 202 is displayed on the intelligent display 8 of the band monitoring device 1 and at the same time is transmitted to the communication unit 5 of the band monitoring device 1. This communication unit 5 transmits the information about the fault component 202, on the one hand, to the programmable logic controller (PLC) 301 of the control system 300. On the other hand, this information is also forwarded via a communication network 50 that is separate from the radio communication system 100.

The PLC 301 puts, with an alarm message 303, the machine 302, which is controlled by the PLC 301, into a safety state, in which the operating speed of the machine 302 is reduced; and a greater latency time in the radio communication system 100 is tolerable, without causing damage to the machine 302. Some of the sensors/actuators 101b-101f, which are logically a part of the radio communication system 100 and are, therefore, depicted inside this system, are physically arranged on the machine 302. This is not shown in FIG. 1 for reasons of clarity.

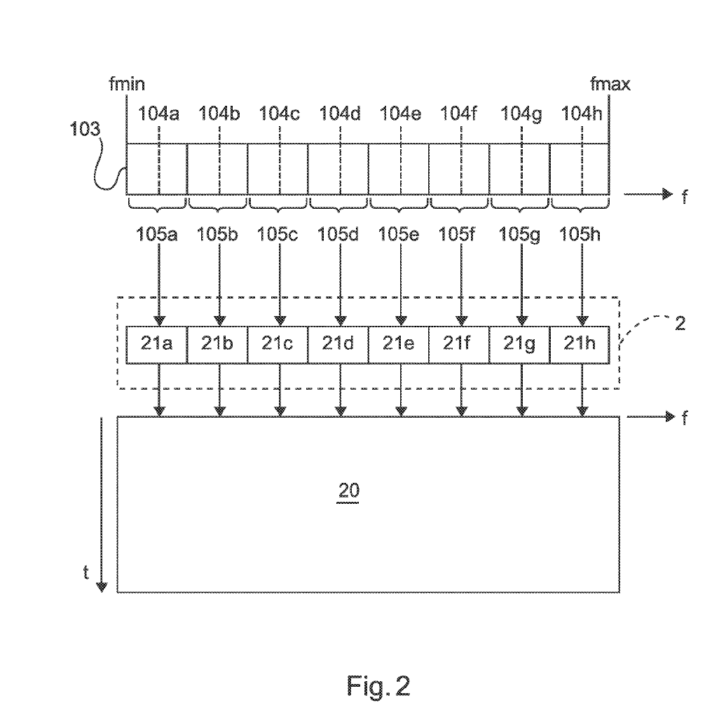

FIG. 2 shows a fast spectrum analyzer 2 that consists of eight simultaneously operating receivers 21a-21h. Each of these receivers 21a-21h is sensitive to a sub-band 105a-105h of the frequency band 103 with medium frequency 104a-104h. The information from all of the receivers 21a-21h is combined for the two dimensional representation 20 of the frequency usage in frequency f and time t. Each receiver 21a-21h regulates its dynamic range independently of the other receivers via an automatic gain control (AGC). In this way, for example, the receiver 21c can still detect a weak jammer 9, while the receiver 21a receives a strong useful signal of the subscriber 101c and is almost saturated by it.

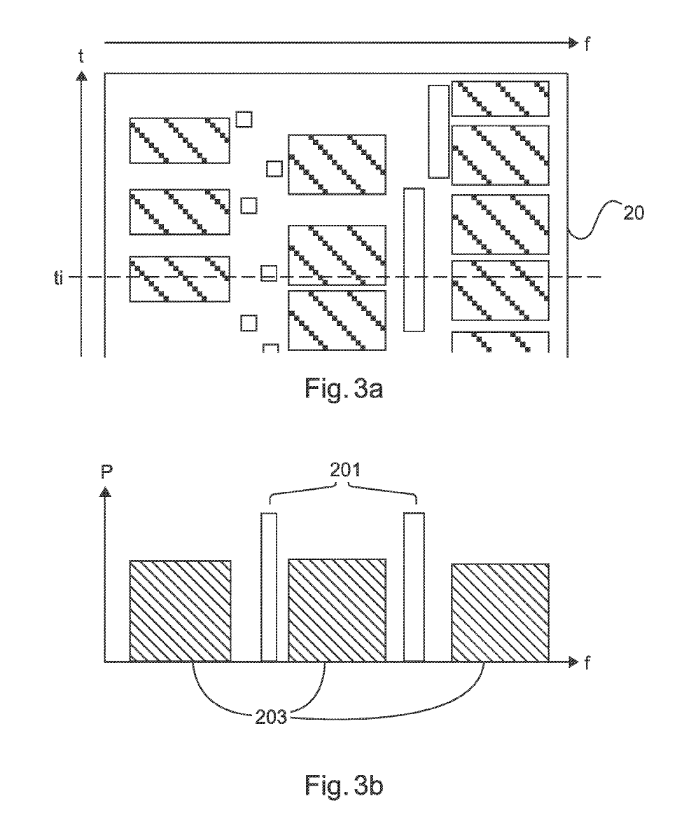

FIGS. 3a and 3b show by way of example the analysis of the time-frequency representation 20 that takes place in the evaluation unit 4 of the band monitoring device 1. In particular, FIG. 3a shows by way of example a section of the time-frequency representation 20. The hatched areas in this representation 20 come from three WLAN networks that are operated in parallel, in addition to the wireless communication system 100. Between the tracks of the WLAN networks are the frequencies f used by the radio communication system 100. The color information, which indicates the respective received power P, is omitted in FIG. 3a.

FIG. 3b shows a section through the time-frequency representation 20 at the time The operation of the three WLAN networks was planned at the time that the radio communication system 100 was designed. Therefore, the associated frequencies f in the memory 3 of the band monitoring device 1 are marked as the frequency usage 203 that is to be ignored. The remaining amplitudes of the received power P are due to the frequency usage, taking place between the WLAN tracks, by the radio communication system 100 and are, therefore, rated by the evaluation unit 4 as a component 201 of the time-frequency representation 20 that is plausible with the fixed sequences 102a-102f of the frequency usage that are associated with the subscribers 101a-101f.

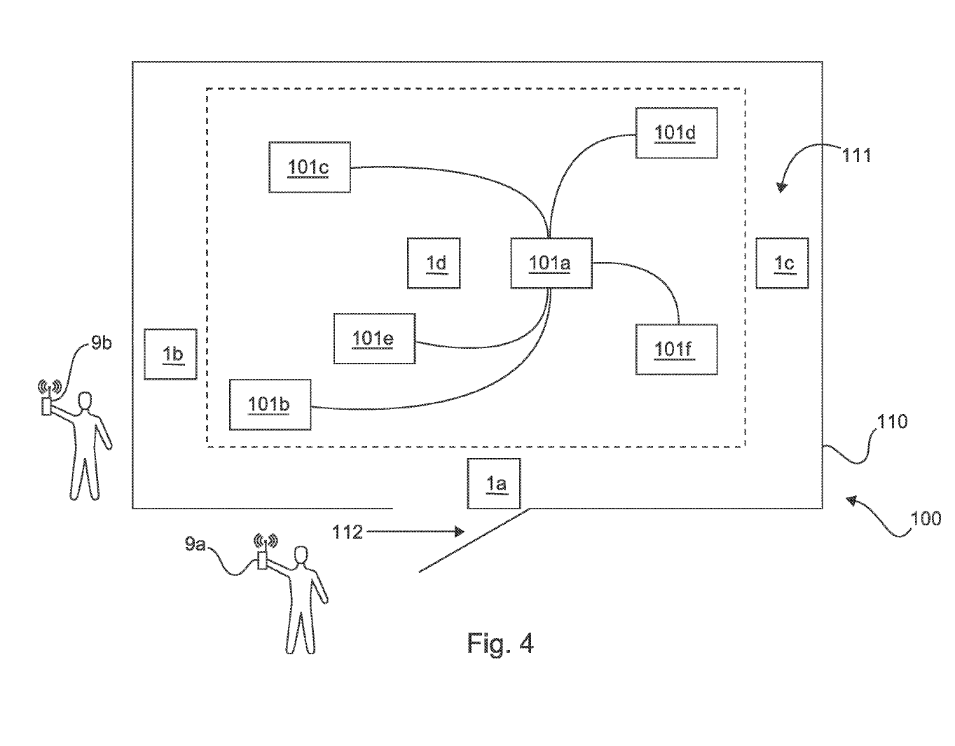

FIG. 4 shows how several band monitoring devices 1a-1d are used in a useful way to detect jammers 9a, 9b at an early stage. The radio communication system 100 supplies a region 110 with edge region 111. The radio communication system comprises the subscribers 101a-101f, where the subscriber 101a is the central base station; and the subscribers 101b-101f are normal sensor/actor modules. In order to illustrate this master/slave relationship, the subscribers 101b-101f are connected in a star-shaped manner to the subscriber 101a by lines.

The first band monitoring device la is located at the entrance 112 of the supplied region 110, which is a manufacturing cell in this case. Two further band monitoring devices 1b and 1c are arranged at other positions in the edge region 111 of the supplied region 110. A fourth band monitoring device 1d is disposed in the immediate vicinity of the base station 101a.

When the jammer 9a approaches the entrance 112, the band monitoring device 1a will respond first. If a corresponding alarm is triggered, then, for example, the door 112 can remain closed, or the control system 300, which contains the radio communication system 100, can be put into a safety state 303.

If the jammer 9b approaches the left boundary of the supplied region 110, then the band monitoring device 1b will similarly respond first. Thus, it is possible to detect the direction, from which a jammer 9a, 9b is coming. This makes it easier to remedy the cause of the fault.

The band monitoring device 1d in the immediate vicinity of the base station 101a has the function of monitoring exactly the reception spectrum, which the base station 101a perceives, for faults. The base station 101a is fine, in so far as it is system relevant for the functioning of the radio communication system 100. If the radio reception at the location of the base station 101a is jammed, the network 100 may fail completely.

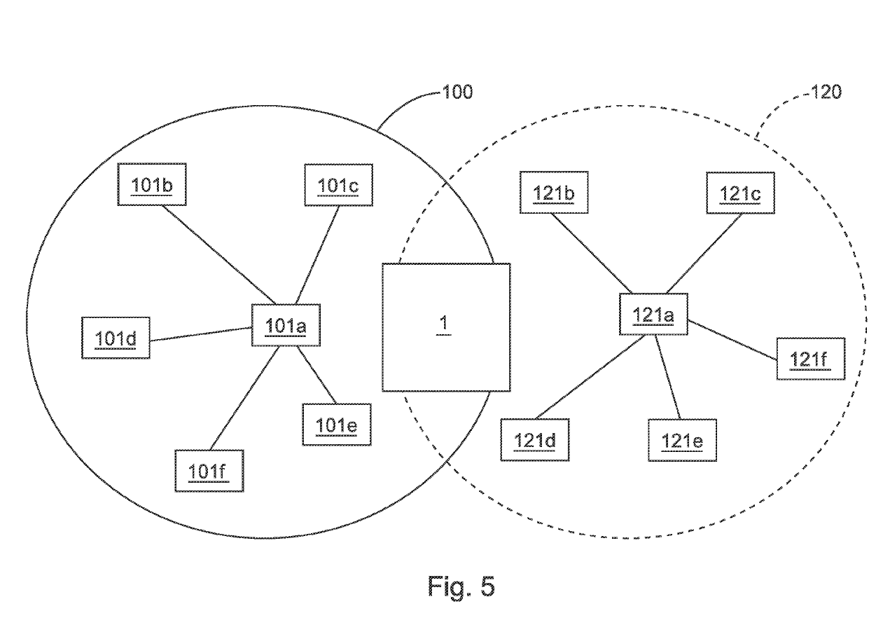

FIG. 5 illustrates how one and the same band monitoring device 1 can be integrated in two radio communication systems 100, 120. The system 100 comprises the subscribers 101a-101f, where the subscriber 101a is the central base station. Similarly the system 120 comprises the subscribers 120a-120f, where the subscriber 120a is the central base station. The band monitoring device 1 is registered in both systems 100, 120 as an additional subscriber and is, therefore, automatically informed about which fixed sequences 102a-102f of frequencies f are allocated to the respective subscribers 101a-101f and 121a-121f, respectively.

What is claimed is:

1. A band monitoring device for a radio communication system in which each of a plurality of subscribers is allocated a fixed sequence of frequencies f to be used, the band monitoring device comprising:
a detector to determine a time-frequency representation of a usage of at least one frequency band of the radio communication system;
a memory to store the fixed sequences; and
an evaluation unit to divide the time-frequency representation into a first component that is plausible with the fixed sequences and into a second component that is inconsistent with the fixed sequence.

2. The band monitoring device of claim 1, further comprising:
a communication unit to enable the band monitoring device to be integrated in the radio communication system as a subscriber.

3. The band monitoring device of claim 1, further comprising:
a communication unit connectable to a wireless or hard-wired communication network other than the radio communication system.

4. The band monitoring device of claim 1, wherein the detector comprises a plurality of simultaneously operating receivers that are each sensitive at a predetermined time to a fixed frequency and/or to a fixed frequency sub-band within the at least one frequency band.

5. The band monitoring device of claim 1, further comprising:
an additional memory to store signal characteristics of the subscribers that are expected at the location of the band monitoring device, wherein the evaluation unit is configured to compare the signal characteristics of a frequency usage that are plausible with the fixed sequence of a subscriber with the expected signal characteristics of the signal received from the subscriber.

6. The band monitoring device of claim 5, wherein the evaluation unit is configured to detect a deviation of the signal characteristics of the expected signal characteristics as an attempt to break into the radio communication system by simulating the identity of the subscriber.

7. The band monitoring device of claim 5, wherein the evaluation unit is switchable into a learning mode in which the evaluation unit determines from the time-frequency representation the fixed sequences and/or the signal characteristics to be expected.

8. The band monitoring device of claim 1, wherein the detector is configured to record a time-frequency representation during at least one send pause assigned to at least one subscriber by the radio communication system.

9. The band monitoring device of claim 1, wherein the evaluation unit is configured to identify a frequency usage as a frequency usage that is in conformity with the TO-Link standard, with a WLAN standard and/or with a Bluetooth standard.

10. A radio communication system operable in a spatial region , comprising:
at least one band monitoring device of claim 1, arranged in an edge region of the spatial region and/or at an access to the spatial region and/or near a central base station of the radio communication system.

11. A distributed industrial control system comprising:
at least one radio communication system comprising at least one band monitoring device according to claim 1; and
at least one control device coupled to the at least one band monitoring device and configured to put the control system into a safety state in response to a detection by the at least one band monitoring device of a component of the frequency usage that is inconsistent with a planned frequency usage in the radio communication system to reduce an effect of a fault in the radio communication system.

12. The control system of claim 11, wherein in the safety state, a maximum tolerable latency time during radio transmission in the radio communication system is increased.

13. The control system of claim 11, wherein in the safety state, an operating speed of at least one device controlled by the control system is reduced, compared to normal operation.
